(19) United States
(12) Patent Application Publication
(10) Pub. No.: US 2026/0285628 A1
(43) Pub. Date: Sep. 24, 2026

(54) CONTROL METHOD, PROCESSING DEVICE, AND NON-TRANSITORY RECORDING MEDIUM

(71) Applicant: CASIO COMPUTER CO., LTD., Tokyo (JP)

(72) Inventor: Masato MOCHIZUKI, Tokyo (JP)

(73) Assignee: CASIO COMPUTER CO., LTD., Tokyo (JP)

(21) Appl. No.: 19/570,522

(22) Filed: Mar. 18, 2026

(30) Foreign Application Priority Data
Mar. 24, 2025 (JP) 2025-048224

(51) Int. Cl. B65H 7/02; B65H 5/06; B26D 5/02; B26F 1/38

(52) U.S. Cl. CPC B65H 7/02; B65H 5/062; B26D 5/02; B26F 1/382; B65H 2301/44318; B65H 2301/5111; B65H 2301/515

(57) ABSTRACT

A control method executed by a computer includes: processing a processing target medium placed on a medium holding member, a protrusion that bites into the medium holding member being formed on a contact surface of a conveyance roller with the medium holding member; controlling a driver by the computer such that a conveyance roller conveys a medium holding member in a first conveyance direction and the medium holding member is sequentially conveyed in a second conveyance direction opposite to the first conveyance direction in a state where a processing portion is separated from a processing target medium; and controlling the driver and the processing portion by the computer based on processing data after controlling the driver such that the processing portion processes the processing target medium while causing the conveyance roller to convey the medium holding member together with the processing target medium.

### CROSS-REFERENCE TO RELATED APPLICATION(S)

This application claims the priority and benefit of JP 2025-048224 filed on March 24, 2025. The entire specification, claims, and drawings of JP 2025-048224 are incorporated herein by reference for all purposes.

### FIELD

The present disclosure relates to a control method, a processing device, and a non-transitory recording medium.

### BACKGROUND

JP-A 2002-104685 discloses a sheet feeding mechanism of a printing apparatus in which a sheet is placed on a belt that has protrusions formed on a surface, and the belt is driven in a state where the protrusions on the belt bite into the sheet so that the sheet is stably conveyed.

### SUMMARY

A control method executed by a computer includes: processing a processing target medium placed on a medium holding member, a protrusion that bites into the medium holding member being formed on a contact surface of a conveyance roller with the medium holding member; controlling a driver by the computer such that the conveyance roller conveys the medium holding member in a first conveyance direction and the medium holding member is sequentially conveyed in a second conveyance direction opposite to the first conveyance direction in a state where the processing portion is separated from the processing target medium; and controlling the driver and the processing portion by the computer based on processing data after controlling the driver such that the processing portion processes the processing target medium while causing the conveyance roller to convey the medium holding member together with the processing target medium.

### BRIEF DESCRIPTION OF THE DRAWINGS

FIG. 1 is a diagram illustrating a configuration example of a processing device from a first viewpoint according to an embodiment;

FIG. 2 is a diagram illustrating a configuration example of a processing device from a second viewpoint according to the embodiment;

FIG. 3 is a diagram illustrating a configuration example of a conveyance roller;

FIG. 4 is a diagram illustrating a state in which a cutter is pressed against a processing target medium;

FIG. 5 is a flowchart illustrating a process performed by the processing device according to the embodiment;

FIG. 6A is a diagram illustrating an example of a pre-conveyance process;

FIG. 6B is a diagram illustrating an example of the pre-conveyance process;

FIG. 7A is a diagram illustrating an example of an initial process;

FIG. 7B is a diagram illustrating an example of an initial process;

FIG. 8A is a diagram illustrating an example of an influence of slippage during conveyance of a mount on processing of a processing target medium;

FIG. 8B is a diagram illustrating an example of an influence of slippage during conveyance of the mount on the processing of the processing target medium; and

FIG. 8C is a diagram illustrating an example of an influence of slippage during conveyance of the mount on the processing on the processing target medium.

### DETAILED DESCRIPTION OF EMBODIMENTS

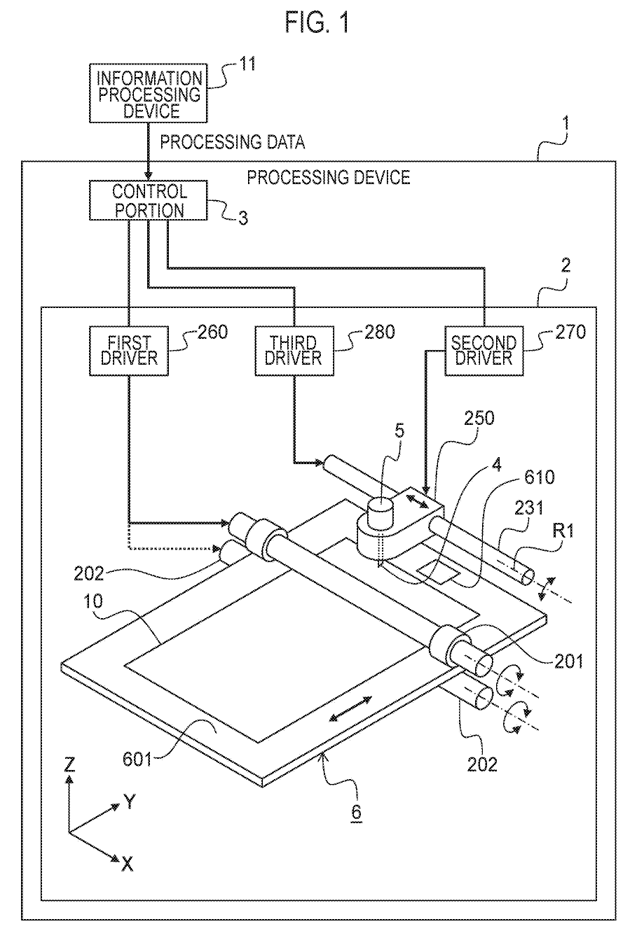

Hereinafter, embodiments of the present invention will be described with reference to the drawings. A processing device 1 according to an embodiment illustrated in FIG. 1 is a device that performs predetermined processing on a sheet-like processing target medium 10 by the processing portion 4 based on processing data. The processing target medium 10 may be, for example, paper, a label seal having an adhesive layer, or the like. The processing portion 4 may be a cutter that has a cutting blade for cutting the processing target medium 10. The processing portion 4 may be a pen or the like for drawing on the processing target medium 10. In the following description, the processing portion 4 is referred to as a cutter 4. The processing device 1 includes a processing portion 2 that includes a mechanical mechanism configured to be able to freely change a relative position of the processing target medium 10 with respect to the cutting blade of the cutter 4, and a control portion 3 that controls an operation of the mechanical mechanism of the processing portion 2. The control portion 3 is an example of a computer that controls an operation of the processing device 1.

In the technique disclosed in JP 2002-104685 A, there is a problem that slippage occurs in the medium holding member conveyed by a conveyance roller when a process of processing the processing target medium is performed. The present disclosure is intended to improve and solve the problem in such a situation, and is intended to inhibit slippage during conveyance of the medium holding member in the processing device.

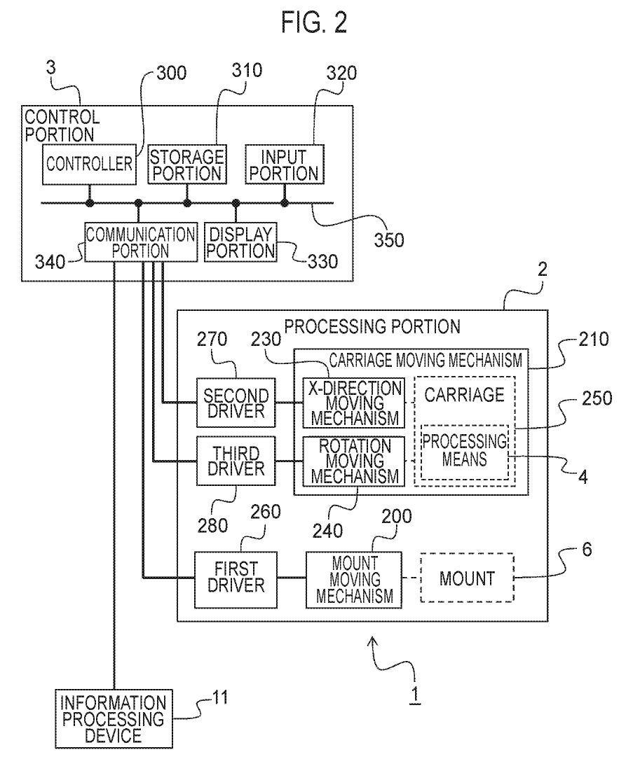

As illustrated in FIG. 2, the processing portion 2 may include a mount moving mechanism 200, a carriage moving mechanism 210, a first drive portion 260, a second drive portion 270, and a third drive portion 280. The mount moving mechanism 200 is a mechanical mechanism that moves a mount 6 on which the processing target medium 10 is placed in a first direction (the Y direction in FIG. 1) and includes a pair of conveyance rollers 201 and 202 illustrated in FIG. 1 and a rotation mechanism (not illustrated) that rotates the pair of conveyance rollers 201 and 202 in directions opposite to each other. The pair of conveyance rollers 201 and 202 is disposed so as to rotate using a second direction (the X direction) orthogonal to the first direction as a rotation axis and to have a positional relationship in which the mount 6 can be nipped. Specific examples of the pair of conveyance rollers 201 and 202 will be described below. The rotation mechanism of the mount moving mechanism 200 is connected to the first drive portion 260 (for example, a stepping motor) and is configured such that, for example, when the first drive portion 260 is driven, one conveyance roller 201 rotates as a drive roller and the other conveyance roller 202 rotates as a driven roller. The carriage moving mechanism 210 includes an X-direction moving mechanism 230 that moves the carriage 250 holding the cutter 4 in the second direction (the X direction in FIG. 1), and a rotation moving mechanism 240 that rotationally moves the carriage 250 about a rotation axis parallel to the second direction (the X direction). The X-direction moving mechanism 230 includes a support member 231 that supports the carriage 250 so as to be movable in the X direction of FIG. 1, and a moving mechanism (not illustrated) that moves the carriage 250 in the X direction. The moving mechanism of the X-direction moving mechanism 230 is connected to the second drive portion 270 (for example, a stepping motor) and is configured such that the carriage 250 moves in the X direction when the second drive portion 270 is driven. The rotation moving mechanism 240 includes a mechanical mechanism (not illustrated) that rotationally moves the carriage 250 such that a cutter blade (not illustrated) of the cutter 4 attached to the carriage 250 is movable between a cutting position and a separation position. The cutting position is a position of the cutter blade at which the processing target medium 10 can be cut by the cutter blade, and the separation position is a position of the cutter blade at which the cutter blade is separated from the processing target medium 10. The rotation moving mechanism 240 is connected to the third drive portion 280 (for example, a stepping motor) and is configured such that the carriage 250 rotationally moves when the third drive portion 280 is driven. As illustrated in FIG. 1, the carriage 250 in the above-described processing portion 2 is configured to hold a cutter holder 5 to which the cutter 4 is attached. The cutter 4 has, for example, a cutter blade at one end of a round bar, and a cutting point of the cutter blade is offset from the axis of the round bar. The cutter holder 5 is configured to support the cutter 4 such that the cutter 4 is rotatable using an axis center of a round bar serving as a rotation axis In the cutter 4 supported by such a cutter holder 5, when a relative position of the processing target medium 10 changes in a predetermined direction in an XY plane with the cutter blade pressed against the processing target medium 10, a direction of the cutter blade automatically changes according to the change. Therefore, in the above-described processing device 1, the drive portion and the mechanical mechanism changing (controlling) the direction of the cutter blade can be omitted, and thus there is the advantage that the device configuration is simplified, and a manufacturing cost is reduced.

The processing portion 2 of the processing device 1 according to the embodiment is not limited to the above-described configuration. For example, the above-described rotation moving mechanism 240 is merely an example of a moving mechanism that moves the cutter blade of the cutter 4 between the cutting position and the separation position. The processing portion 2 may include a mechanical mechanism that moves the cutter 4 in a third direction (the Z direction) orthogonal to the first direction (the Y direction) and the second direction (the X direction) instead of the rotation moving mechanism 240. The processing portion 2 may include a drive portion and a mechanical mechanism changing (controlling) a direction of the cutter blade.

An operation of each mechanism of the above-described processing portion 2 is controlled by the control portion 3. The control portion 3 controls operations (specifically, operations of the first drive portion 260, the second drive portion 270, and the third drive portion 280) of the processing portion 2 based on, for example, processing data (see FIG. 1) acquired from the information processing device 11 that is an external device. The control portion 3 is an example of a computer that controls an operation of the processing device 1 as described above. The information processing device 11 may be or includes a computer capable of executing an application generating the processing data and transmitting the processing data to the processing device 1 and capable of communicating with the processing device 1. The information processing device 11 may be, for example, a smartphone, a tablet computer, or another personal computer.

For example, as illustrated in FIG. 2, the control portion 3 includes a controller 300, a storage portion 310, an input portion 320, display portions 330 and 340, which can be connected to each other by a bus 350. A hardware configuration of the control portion 3 may be the same as a hardware configuration of the known processing device 1. The controller 300 can be a processor such as a central processing portion (CPU) as one or more processors that execute a control program for controlling an operation of the processing device 1. The storage portion 310 includes a read only memory (ROM) and a random access memory (RAM) that store a control program, processing data acquired from the information processing device 11, and the like. The input portion 320 can be an input device such as a switch or a keyboard that inputs various types of information regarding the operation of the processing device 1. The display portion 330 can be a display device such as a lamp or a display that visualizes and displays various types of information including an operation state of the processing device 1. The communication portion 340 may include a first hardware interface that transmits control signals to the first drive portion 260, the second drive portion 270, and the third drive portion 280 via transmission cables, and a second hardware interface that enables communication with the information processing device 11 (see FIG. 1). Communication with the information processing device 11 may be either or both of wireless communication conforming to a short-range wireless communication standard such as Bluetooth Low Energy (registered trademark) or wired communication via a transmission cable such as a Universal Serial Bus (USB) cable. The control portion 3 of the processing device 1 according to the embodiment is not limited to the above-described configuration. The control portion 3 may include, for example, a hardware interface that reads and writes information from and to a portable storage device such as a memory card (card-type storage device) or a USB memory.

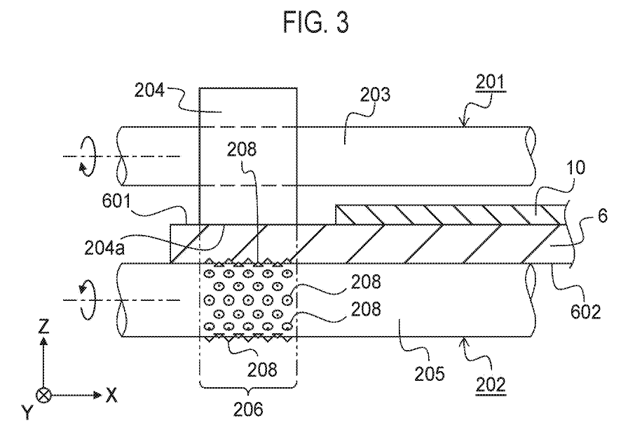

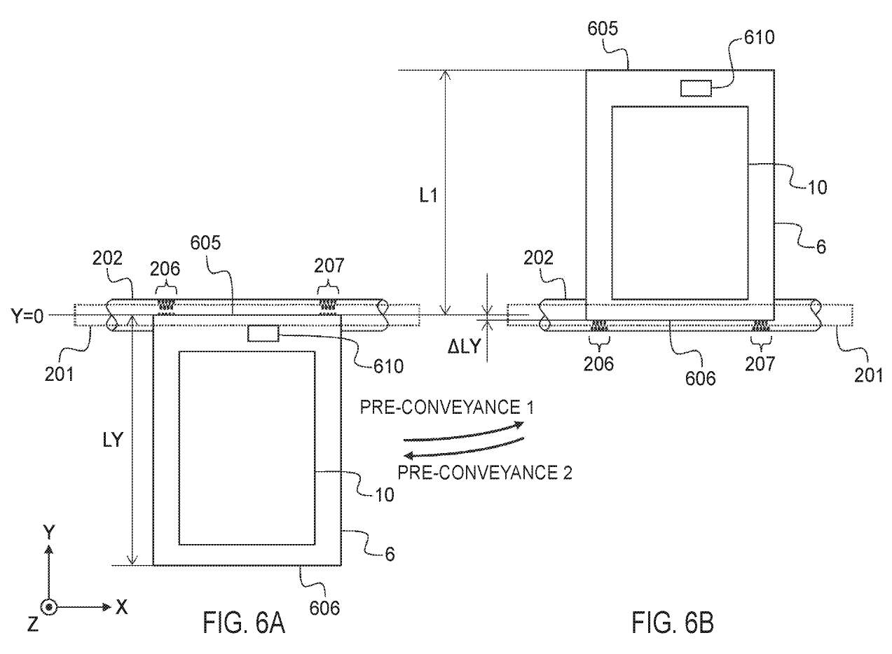

The control portion 3 of the processing device 1 according to the embodiment can control a conveyance direction and a conveyance amount of the mount 6 nipped between the pair of conveyance rollers 201 and 202. The processing device 1 can convey the mount 6 in a first conveyance direction in which a relative position of the mount 6 with respect to the conveyance rollers 201 and 202 moves in the +Y direction in FIG. 1, and can convey the mount 6 in a second conveyance direction opposite to the first conveyance direction. The mount 6 is an example of a flat-shaped medium holding member that holds the processing target medium 10. An upper surface 601 of the mount 6 has a belt-like roller contact region which is located outside of a region where the processing target medium 10 is placed and comes into contact with the conveyance roller 201 during conveyance. There is the roller contact region on a positive side in the X direction (+X direction side) and a negative side in the X direction (-X direction side) with respect to the region where the processing target medium 10 is placed. The conveyance roller 201 passing above the mount 6 (+Z direction side) includes, for example, a round bar 203 and an annular diameter expansion member 204 attached to the round bar 203 as illustrated in FIG. 3. The diameter expansion member 204 may be referred to as a platen. A diameter of the round bar 203 and a diameter of the outer peripheral side surface 204a of the diameter expansion member 204 are set so that the processing target medium 10 does not come into contact with the round bar 203 when the outer peripheral side surface 204a is brought into contact with the upper surface 601 of the mount 6 to convey the mount 6. In the conveyance roller 202 passing under the mount 6 (-Z direction side), a plurality of protrusions 208 are formed on a region 206 facing an outer peripheral side surface 204a of the diameter expansion member 204 on the side surface of the round bar 205. The region 206 where the plurality of protrusions 208 are provided goes around the side surface of the round bar 205 one time, and the plurality of protrusions 208 in the region 206 bite into a lower surface 602 of the mount 6 when the mount 6 is conveyed, and thus it is possible to prevent slippage of the mount 6 to the conveyance roller 202 (the round bar 205). FIG. 3 illustrates only a configuration example of the mount 6 on the negative side in the X direction with respect to the region on which the processing target medium 10 is placed, in the pair of conveyance rollers 201 and 202, but a configuration of the mount 6 on the positive side in the X direction with respect to the region on which the processing target medium 10 is placed may be similar. In the conveyance roller 202, for example, a protrusion may not be formed in a region 207 (see FIGS. 6A and 6B) facing the outer peripheral side surface 204a of the diameter expansion member 204 located on the positive side in the X direction with respect to the region where the processing target medium 10 is placed.

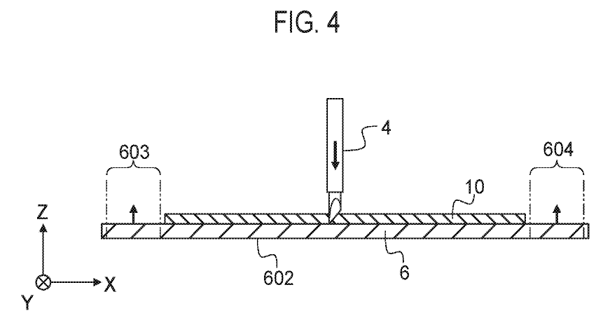

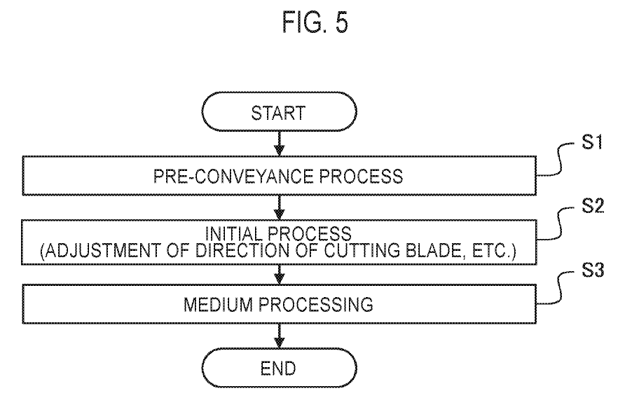

When the processing target medium 10 placed on the mount 6 is cut by the cutter 4 in the processing device 1, the processing target medium 10 receives a load in a direction different from the conveyance direction of the processing target medium 10 from the cutter blade of the cutter 4. Therefore, when the plurality of protrusions 208 of the conveyance roller 202 shallowly bite into the mount 6 during conveyance of the mount 6, a movement of the mount 6 in the conveyance direction is hindered by the load received by the processing target medium 10 from the cutter blade, and the slippage of the mount 6 may occur. For example, as illustrated in FIG. 4, the processing target medium 10 and the mount 6 receive a downward pressing load from the cutter 4 pressed against the processing target medium 10 from above. At this time, the mount 6 is warped such that the lower surface 602 becomes a slightly downward convex curved surface, and the biting of the plurality of protrusions 208 of the conveyance roller 202 into the contact regions 603 and 604 at the ends may become shallow. The factor of the shallow biting of the protrusion 208 into the lower surface 602 of the mount 6 is not limited to the factor described above with reference to FIG. 4. The slippage during conveyance of the mount 6 caused due to the shallow biting of the protrusions 208 into the mount 6 causes a deviation between the conveyance amount of the mount 6 based on the processing data and an actual conveyance amount of the mount 6. Therefore, a deviation occurs between a position to be processed on the processing target medium 10 and a position actually processed based on the processing data, and processing accuracy (processing quality) deteriorates. In order to inhibit a deterioration in processing accuracy due to slippage during conveyance of the above-described mount 6, the processing device 1 according to the embodiment performs, for example, the process illustrated in FIG. 5 when the processing target medium 10 is processed based on the processing data. The processes of steps S1 to S3 illustrated in FIG. 5 are mainly performed by the controller 300 of the control portion 3.

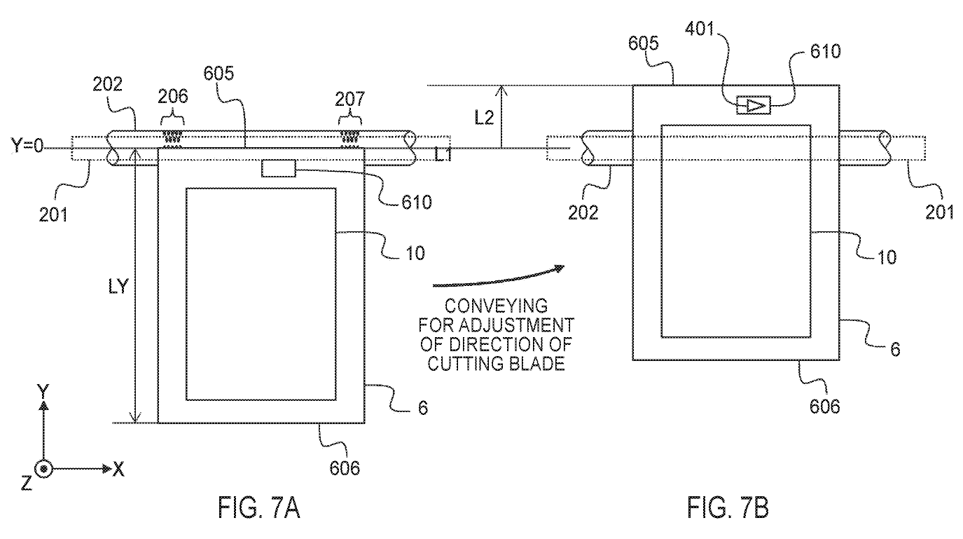

The controller 300 of the control portion 3 performs a pre-conveyance process (step S1) before the medium processing (step S3) of processing the processing target medium 10 based on the processing data. For example, as illustrated in FIG. 6A, the pre-conveyance process is started in a state where one end 605 of the mount 6 on which the processing target medium 10 is placed in the conveyance direction is nipped between the pair of conveyance rollers 201 and 202. For example, as illustrated in FIGS. 6A and 6B, the pre-conveyance process includes a first conveyance process of conveying the mount 6 nipped by the pair of conveyance rollers 201 and 202 by a distance (conveyance amount) L1 in the +Y direction and a second conveyance process of conveying the mount 6 by a distance L1 in the -Y direction after the first conveyance process. The distance L1 by which the mount 6 is conveyed may be a size obtained by subtracting a predetermined minute dimension ΔLY from a dimension LY (distance from one end 605 to the other end 606 in the conveyance direction) in the conveyance direction of the mount 6. The minute dimension ΔLY may be a dimension necessary for preventing the mount 6 conveyed in the +Y direction from separating from the pair of conveyance rollers 201 and 202 (in other words, in order to maintain a state in which the mount 6 is nipped by the pair of conveyance rollers 201 and 202). In the pre-conveyance process, the controller 300 performs only control for driving the first drive portion 260 (see FIG. 2) to convey the mount 6, and does not perform control for processing the processing target medium 10 by the cutter 4 (processing portion). In other words, the first and second conveyance processes of the pre-conveyance process are performed with the cutter 4 separated from the processing target medium 10. Therefore, in the pre-conveyance process, it is possible to prevent slippage of the mount 6 due to a load from the cutter 4, it is possible to cause the plurality of protrusions 208 formed in the regions 206 and 207 of the conveyance roller 202 to firmly bite into the lower surface 602 of the mount 6, and it is possible to cause a bite mark of the protrusions 208 having a sufficient depth on the lower surface 602 of the mount 6. By setting the distance L1, which can be the conveyance amount of the mount 6 in the pre-conveyance process, to be substantially the same as the dimension LY of the mount 6 in the Y direction, it is possible to convey the mount 6 such that the protrusions 208 are always fitted into the bite mark of the mount 6 having a sufficient depth regardless of the conveyance direction and the conveyance amount of the mount 6 in a subsequent process, and it is possible to reliably inhibit slippage during conveyance of the mount 6. After the pre-conveyance process, the controller 300 performs an initial process (step S2) including a process of adjusting a direction of the cutting blade of the cutter 4. The initial process of step S2 may be a process performed before the medium processing (step S3) of processing the processing target medium 10 based on the processing data in the known processing device 1. For example, as illustrated in FIG. 7A, the initial process is started in a state where one end 605 of the mount 6 on which the processing target medium 10 is placed in the conveyance direction is nipped between the pair of conveyance rollers 201 and 202. A relative position of the mount 6 to the pair of conveyance rollers 201 and 202 in FIG. 7A is substantially the same as the relative position in FIG. 6A. In the mount 6 of FIG. 7A, a mark (bite mark) in which a plurality of protrusions 208 formed in the regions 206 and 207 of the conveyance roller 202 bite is formed on the lower surface 602 (not illustrated). In the initial process, in order to adjust the direction of the cutting blade of the cutter 4, first, as illustrated in FIG. 7B, the controller 300 performs a process of conveying the mount 6 nipped by the pair of conveyance rollers 201 and 202 in the +Y direction by a distance (conveyance amount) L2, pressing the cutting blade 401 of the cutter 4 held by the carriage 250 (see FIG. 1) against a cutting-edge adjusting region 610 of the mount 6. Thereafter, the controller 300 performs control for changing the relative position of the mount 6 with respect to the cutter 4 so as to be in the direction of the cutting blade 401 when cutting of the processing target medium 10 starts. The initial process may be only a process of adjusting the direction of the above-described cutting blade 401 or may include other known processes. After the initial process, the controller 300 performs medium processing (step S3) of processing (cutting) the processing target medium 10 based on the processing data. In the medium processing, the controller 300 performs control similar to that of a known processing device. When the medium processing ends, the controller 300 transmits, for example, a message indicating that the processing of the processing target medium 10 ends to the information processing device 11 and ends the series of processes.

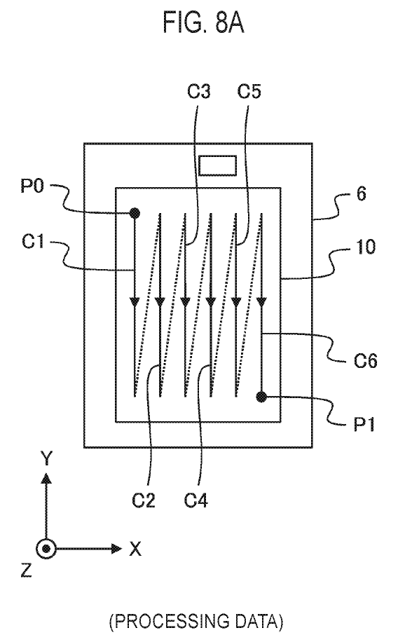

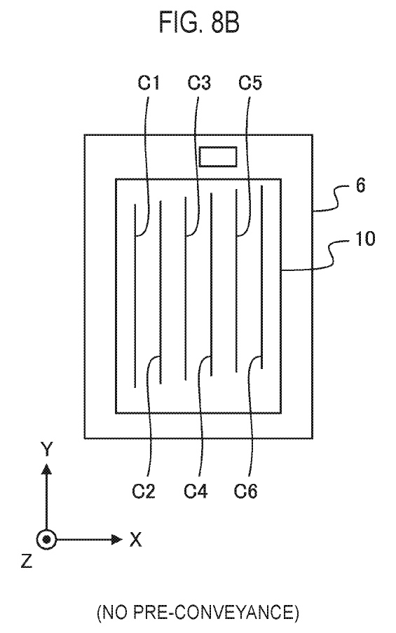

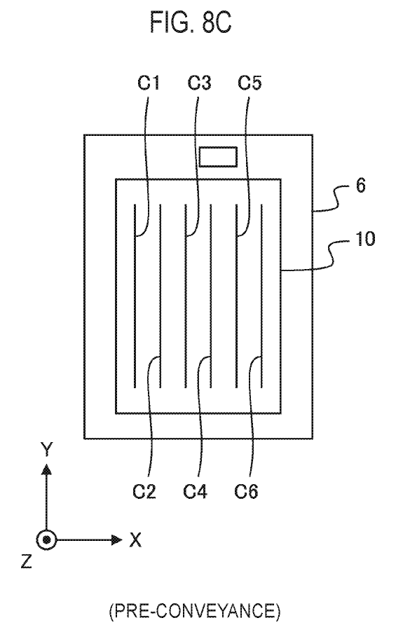

When the medium processing (step S3) is performed in the processing device 1 according to the embodiment, a mark (bite mark) obtained by biting the plurality of protrusions 208 formed in the regions 206 and 207 of the conveyance roller 202 is formed on the lower surface 602 of the mount 6 at a depth sufficient to inhibit slippage of the mount 6. Therefore, even when a load in a direction different from the conveyance direction acts on the mount 6 from the cutter 4 (processing portion) in the medium processing, the protrusions 208 of the conveyance roller 202 are firmly fitted in the bite mark of the lower surface 602 of the mount 6, and thus the slippage of the mount 6 during conveyance can be prevented. An example of a difference in processing accuracy between a case where the pre-conveyance process is not performed and a case where the pre-conveyance process is performed will be described with reference to FIGS. 8A to 8C. FIG. 8A illustrates cutting lines C1 to C6 in the processing data superimposed on the processing target medium 10 placed on the mount 6. The cutting lines C1 to C6 extend in the Y direction that is the conveyance direction of the mount 6 and are arranged in parallel in a direction orthogonal to the conveyance direction. The processing data can include information indicating cutting paths of the cutting lines C1 to C6. FIG. 8A illustrates, as an example, paths along which cutting is performed one by one from one end P0 of the cutting line C1. The controller 300 of the processing device 1 performs a cutting process of cutting the mount 6 from one end P0 to the other end of the cutting line C1 set on the processing target medium 10 while conveying the mount 6 in the +Y direction, and a position changing process including a process of conveying the mount 6 in the -Y direction and a process of moving the position of the cutting blade (not illustrated) of the cutter 4 in the X direction to the position of the cutting line C2. Thereafter, the above-described cutting process and position changing process are repeated. When the cutting process of performing cutting from one end to the other end P1 of the cutting line C6 ends, the controller 300 ends the processing on the processing target medium 10. In a processing device of the related art that does not perform the above-described pre-conveyance process (step S1), for example, the cutting process of the first cutting line C1 is performed in a state where there is no bite mark on the lower surface 602 of the mount 6. In this case, for example, when the protrusions 208 of the conveyance roller 202 bite shallowly into the mount 6 being conveyed in the first conveyance direction (+Y direction), the processing target medium 10 receives a load in a direction opposite to the conveyance direction from the cutting blade of the cutter 4, which results in occurrence of slippage of the mount 6. In this example, the conveyance amount (movement amount) of the mount 6 conveyed in the first conveyance direction is less than the conveyance amount based on the processing data. On the other hand, when the mount 6 is conveyed in the second conveyance direction to cut the next cutting line C2 after the cutting of the cutting line C1, the cutter 4 is separated from the processing target medium 10. Therefore, the mount 6 is conveyed by the conveyance amount based on the processing data without slippage. Therefore, when the processing target medium 10 is cut along the cutting lines C1 to C6 by the processing device of the related art, for example, as illustrated in FIG. 8B, the positions of the cutting lines C1 to C6 on the processing target medium 10 may be displaced in the +Y direction. On the other hand, the processing device 1 according to the embodiment performs the above-described pre-conveyance process (step S1) to generate a bite mark of the protrusions 208 having a sufficient depth on the lower surface 602 of the mount 6. Therefore, slippage during conveyance of the mount 6 is less likely to occur. For example, as illustrated in FIG. 8C, it is possible to prevent displacement in the +Y direction from occurring at the positions of the cutting lines C1 to C6 on the processing target medium 10.

As described above, the processing device 1 according to the embodiment performs only the process of conveying the mount 6 in a state where the cutter 4 is separated from the processing target medium 10 before processing of the processing target medium 10 based on the processing data, and causes the protrusions 208 having a sufficient depth to bite into the lower surface 602 of the mount 6. Therefore, it is possible to inhibit slippage of the mount 6 when a load is applied from the processing portion to the mount 6 during conveyance of the mount 6 in the medium processing for processing the processing target medium 10. As described above with reference to FIG. 5, before the initial process (step S2) and the medium processing (step S3) performed by the processing device of the related art, the processing device 1 according to the embodiment performs the pre-conveyance process (step S1) of forming a bite mark of the protrusion 208 on the lower surface 602 of the mount 6 in a state where a load from the processing portion (cutter) 4 is not applied to the mount 6. Therefore, it is possible to inhibit slippage during conveyance of the mount 6 only by changing a control program executed by a control portion (controller) of a known processing device. Accordingly, it is possible to prevent deterioration in processing accuracy due to slippage of the mount 6 without changing the specifications of the processing device and the mount. The pre-conveyance process (step S1) is automatically performed before the initial process (step S2) and the medium processing (step S3) performed by the processing device of the related art. Therefore, for example, even when the mount 6 nipped by the pair of conveyance rollers 201 and 202 is a new product (unused product) having no bite mark, it is possible to inhibit slippage during conveyance of the mount 6 in the initial process (step S2) and the medium processing (step S3). Accordingly, a user can operate the processing device 1 to process the processing target medium 10 without being conscious (checking) whether the bite mark of the protrusions 208 is generated on the lower surface 602 of the mount 6.

The above-described embodiments are specific examples to facilitate understanding of the invention, and the present invention is not limited to the above-described embodiments. The program, the processing device, and the control method can be variously modified and changed without departing from the scope of the claims. For example, the processing portion 4 in the processing device 1 may be a pen or the like that draws on the surface of the processing target medium 10. The pre-conveyance process (step S1) in FIG. 5 is not limited to the pre-process when the processing portion 4 processes the processing target medium 10 based on the processing data. For example, the controller 300 of the processing device 1 may perform a conveyance process similar to the pre-conveyance process at any timing in response to a user operation on the input portion 320, a control signal from the information processing device 11, or the like, and may generate a bite mark with a sufficient depth on the lower surface 602 of the mount 6. In this example, the processing target medium 10 may not be placed on the mount 6 to be conveyed. For example, the plurality of protrusions 208 of the conveyance roller 202 may be formed only in one of the two regions 206 and 207 illustrated in FIG. 6A. In other words, the plurality of protrusions 208 of the conveyance roller 202 may be formed so as to generate a bite mark at one end of the ends in the extending direction (X direction) of the axis of the conveyance roller 202 in the mount 6. The shape and arrangement of the plurality of protrusions 208 for preventing the slippage of the mount 6 on the conveyance roller 202 are not limited to a specific shape and a specific arrangement. The plurality of protrusions 208 are formed on the conveyance roller in contact with the back surface of the surface of the mount 6 against which the processing portion 4 is pressed. Therefore, in the case of a processing device in which the processing portion 4 is pressed from below (-Z direction side) the mount 6, the plurality of protrusions 208 are formed on a conveyance roller disposed above (+Z direction side) the mount 6.

The conveyance amount L1 of the above-described mount 6 in the first conveyance direction with reference to FIGS. 6A and 6B with respect to the pre-conveyance process (step S1) may be set based on, for example, a range in which the plurality of protrusions 208 of the conveyance roller 202 on the lower surface 602 of the mount 6 bite when the mount 6 is conveyed in the initial process (step S2) and the medium processing (step S3) of FIG. 5. For example, when a region to be processed by the processing portion (cutter) 4 is set only in a portion close to the end on the positive side in the Y direction of the processing target medium 10 in FIGS. 6A and 6B based on the processing data, the conveyance amount L1 of the mount 6 in the pre-conveyance process may be a size of 1/2, 1/3, or 2/3 of the dimension LY of the mount 6 in the Y direction, or the like. In this way, it is possible to shorten a time required for the pre-conveyance process.

The processing device 1 may include a determination portion that determines whether the bite mark of the plurality of protrusions 208 of the conveyance roller 202 is generated on the lower surface 602 of the mount 6. The determination portion may be, for example, a sensor that detects a bite mark (recess) on the lower surface 602 of the mount 6. When individual identification information is assigned to each of the plurality of mounts 6, the processing device 1 may include an acquisition portion that acquires the identification information of the mount 6 used in the processing device 1, and may store the acquired identification information in the storage portion 310. The determination portion in this example can be, for example, the controller 300 that executes a process of determining whether the identification information acquired by the acquisition portion is stored in the storage portion 310 when the process of processing the processing target medium 10 starts based on the processing data.

What is claimed is:

1. A control method executed by a computer, comprising:
processing a processing target medium placed on a medium holding member, a protrusion that bites into the medium holding member being formed on a contact surface of a conveyance roller with the medium holding member;
controlling a driver such that the conveyance roller conveys the medium holding member in a first conveyance direction and the medium holding member is sequentially conveyed in a second conveyance direction opposite to the first conveyance direction in a state where the processing portion is separated from the processing target medium; and
controlling the driver and the processing portion based on processing data after controlling the driver such that the processing portion processes the processing target medium while causing the conveyance roller to convey the medium holding member together with the processing target medium.

2. The control method according to claim 1, wherein
a movement distance indicating a conveyance amount during conveyance of the medium holding member in the first conveyance direction in the controlling of the driver is substantially identical to a distance from one end to the other end of the medium holding member in the conveyance direction.

3. The control method according to claim 1, wherein
a movement distance indicating a conveyance amount during conveyance of the medium holding member in the first conveyance direction in the controlling of the driver is set based on a distance from one end to the other end of the medium holding member in the conveyance direction and a range of a region to be processed by the processing portion based on the processing data in the processing target medium placed on the medium holding member.

4. The control method according to claim 2, wherein
a movement distance indicating a conveyance amount during conveyance of the medium holding member in the first conveyance direction in the controlling of the driver is set based on a distance from one end to the other end of the medium holding member in the conveyance direction and a range of a region to be processed by the processing portion based on the processing data in the processing target medium placed on the medium holding member.

5. The control method according to claim 1, wherein
the computer:
determines whether there is a mark formed by the protrusion biting into a surface of the medium holding member coming into contact with the conveyance roller and
controls the driver when the computer determines that there is no mark.

6. The control method according to claim 2, wherein
the computer:
determines whether there is a mark formed by the protrusion biting into a surface of the medium holding member coming into contact with the conveyance roller, and
controls the driver when the computer determines that there is no mark.

7. The control method according to claim 3, wherein
the computer:
determines whether there is a mark formed by the protrusion biting into a surface of the medium holding member coming into contact with the conveyance roller, and
controls the driver when the computer determines that there is no mark.

8. The control method according to claim 4, wherein
the computer:
determines whether there is a mark formed by the protrusion biting into a surface of the medium holding member coming into contact with the conveyance roller, and
controls the driver when the computer determines that there is no mark.

9. A processing device comprising:
a conveyance roller configured to convey a medium holding member;
a driver that drives the conveyance roller; and
a processing portion that processes a processing target medium placed on the medium holding member, wherein
a protrusion biting into the medium holding member is formed on a contact surface of the conveyance roller with the medium holding member, and
the processing device further comprises one or more processors that:
control the driver such that the conveyance roller conveys the medium holding member in a first conveyance direction and the medium holding member is sequentially conveyed in a second conveyance direction opposite to the first conveyance direction in a state where the processing portion is separated from the processing target medium, and
control the driver and the processing portion based on processing data after controlling the driver such that the processing portion processes the processing target medium while causing the conveyance roller to convey the medium holding member together with the processing target medium.

10. The processing device according to claim 9, wherein
a movement distance indicating a conveyance amount during conveyance of the medium holding member in the first conveyance direction in the controlling of the driver is substantially identical to a distance from one end to the other end of the medium holding member in the conveyance direction.

11. The processing device according to claim 9, wherein
a movement distance indicating a conveyance amount during conveyance of the medium holding member in the first conveyance direction in the controlling of the driver is set based on a distance from one end to the other end of the medium holding member in the conveyance direction and a range of a region to be processed by the processing portion based on the processing data in the processing target medium placed on the medium holding member.

12. The processing device according to claim 10, wherein
a movement distance indicating a conveyance amount during conveyance of the medium holding member in the first conveyance direction in the controlling of the driver is set based on a distance from one end to the other end of the medium holding member in the conveyance direction and a range of a region to be processed by the processing portion based on the processing data in the processing target medium placed on the medium holding member.

13. The processing device according to claim 9, wherein
the one or more processors:
determine whether there is a mark formed by the protrusion biting into a surface of the medium holding member coming into contact with the conveyance roller and
perform a pre-conveyance process when it is determined that there is no mark.

14. The processing device according to claim 10, wherein
the one or more processors:
determine whether there is a mark formed by the protrusion biting into a surface of the medium holding member coming into contact with the conveyance roller and
control the driver when it is determined that there is no mark.

15. The processing device according to claim 11, wherein
the one or more processors:
determine whether there is a mark formed by the protrusion biting into a surface of the medium holding member coming into contact with the conveyance roller and
control the driver when it is determined that there is no mark.

16. The processing device according to claim 12, wherein
the one or more processors:
determine whether there is a mark formed by the protrusion biting into a surface of the medium holding member coming into contact with the conveyance roller and
control the driver when it is determined that there is no mark.

17. A computer-readable non-transitory recording medium recording a program causing a computer to perform:
a process of processing a processing target medium placed on a medium holding member, a protrusion that bites into the medium holding member being formed on a contact surface of a conveyance roller with the medium holding member;
a process of controlling a driver such that the conveyance roller conveys the medium holding member in a first conveyance direction and the medium holding member is sequentially conveyed in a second conveyance direction opposite to the first conveyance direction in a state where the processing portion is separated from the processing target medium; and
a process of controlling the driver and the processing portion based on processing data after controlling the driver such that the processing portion processes the processing target medium while causing the conveyance roller to convey the medium holding member together with the processing target medium.
